(19) United States
(12) Patent Application Publication
(10) Pub. No.: US 2006/0050896 A1
(43) Pub. Date: Mar. 9, 2006

(54) Method and apparatus to compensate a phase of a subwoofer channel signal

(76) Inventor: Ho-young Sung, Sawon-si (KR)

Correspondence Address: STANZIONE & KIM, LLP, 919 18TH STREET, N.W., SUITE 440, WASHINGTON, DC, 20006, US

(21) Appl. No.: 11/126,245

(22) Filed: May 11, 2005

(30) Foreign Application Priority Data
Sep. 6, 2004 (KR) 2004-70780

(51) Int. Cl. H04R 1/40; H04R 3/00

(52) U.S. Cl. 381/97; 381/96

(57) ABSTRACT

A method and an apparatus to adjust a phase of a subwoofer channel signal in order to compensate for a phase difference generated at a crossover point between a subwoofer response and a main speaker response. The method includes: measuring a first response characteristic of a signal output from the subwoofer, a second response characteristic of a signal output from the main speaker, and a third response characteristic of a test signal simultaneously output from the subwoofer and the main speaker, detecting a phase difference between the subwoofer and the main speaker according to a difference value between the first, second, and third response characteristics at a crossover frequency, calculating a delay value of the subwoofer according to the detected phase difference, and compensating for the detected phase difference at the crossover point between the subwoofer and the main speaker using the calculated delay value of the subwoofer.

### CROSS-REFERENCE TO RELATED APPLICATIONS

This application claims priority from Korean Patent Application No. 2004-70780, filed on Sep. 6, 2004, in the Korean Intellectual Property Office, the disclosure of which is incorporated herein in its entirety by reference.

### BACKGROUND OF THE INVENTION

1. Field of the Invention

The present general inventive concept relates to an audio reproducing system having a subwoofer and a main speaker, and more particularly, to a method and an apparatus to adjust a subwoofer channel signal to compensate for a phase difference between the subwoofer channel signal and a main speaker channel signal generated at a crossover point between a subwoofer response and a main speaker response.

2. Description of the Related Art

A subwoofer is a bass only speaker that is commonly included in an audio reproducing system having 2.1 channels or 5.1 channels. A response characteristic of the subwoofer typically crosses over a response characteristic of a main channel (satellite or stereo channel) speaker at a crossover frequency. If phases of a subwoofer channel signal and a main channel signal are different, a notch is generated at a crossover point.

Therefore, the phase difference between the subwoofer channel signal and the main channel signal must be compensated for by detecting a matching status between the response characteristic of the subwoofer and the response characteristic of the main channel speaker.

In a conventional method, a user manually matches the phases of the subwoofer channel signal and the main channel signal by turning over a polarity of a signal or turning a knob while listening in order to match the phases of the subwoofer channel signal and the main channel signal at the crossover point between the subwoofer and the main channel speaker.

However, it is troublesome to the user to manually compensate for the phase difference between the subwoofer channel signal and the main channel signal, and it is difficult for the user to select a correct matching status.

### SUMMARY OF THE INVENTION

The present general inventive concept provides a method and an apparatus to adjust a phase of a subwoofer channel signal to compensate for a phase difference between a subwoofer and a main speaker at a crossover frequency.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of compensating for a phase difference at a crossover point between a main speaker and a subwoofer in an audio reproducing device having separate subwoofer and main speaker channels, the method comprising: measuring a first response characteristic of a signal output from the subwoofer, a second response characteristic of a signal output from the main speaker, and a third response characteristic of a test signal simultaneously output from the subwoofer and the main speaker, detecting a phase difference between the subwoofer and the main speaker according to a difference value between the first, second, and third response characteristics at a crossover frequency, calculating a delay value of the subwoofer according to the detected phase difference, and compensating for the detected phase difference at the crossover point between the subwoofer and the main speaker using the calculated delay value of the subwoofer.

The foregoing and/or other aspects and advantages of the present general inventive concept may also be achieved by providing an audio reproducing device having separate subwoofer and main speaker channels, the device comprising: a micro-processor to detect a phase difference at a crossover point using difference values between respective response characteristics of signals output from a subwoofer and a main speaker and a response characteristic of a test signal simultaneously output from the subwoofer and the main speaker and to delay a subwoofer audio signal by a delay value of the subwoofer determined according to the detected phase difference, and amplifiers to respectively amplify a main speaker audio signal and the delayed subwoofer audio signal output from the micro-processor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an apparatus to compensate a phase of a subwoofer channel signal according to an embodiment of the present general inventive concept;

FIG. 2 is a diagram illustrating frequency responses of a main speaker channel and a subwoofer channel;

FIG. 3 is a diagram illustrating a phase detector of the compensation apparatus of FIG. 1; and

FIG. 4 is a flowchart illustrating a method of detecting and compensating for a phase difference at a crossover point according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

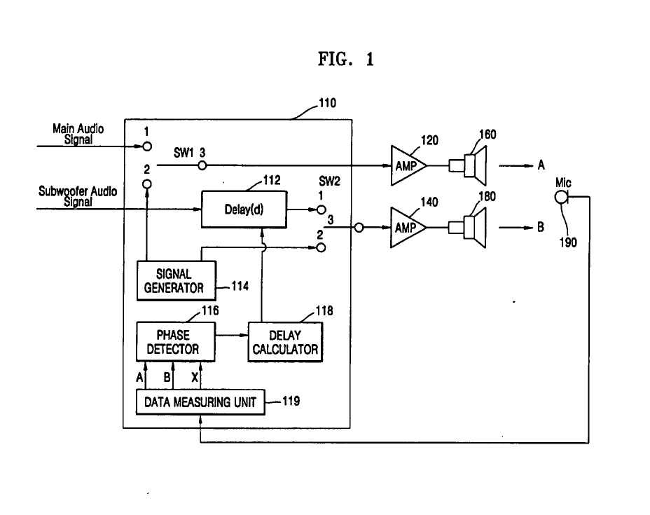

FIG. 1 is a block diagram illustrating an apparatus to compensate a phase of a subwoofer channel signal according to an embodiment of the present general inventive concept.

Referring to FIG. 1, the compensation apparatus includes a micro-processor 110, a first amplifier 120, a second amplifier 140, a main speaker 160, a subwoofer 180, and a microphone 190. The micro-processor 110 includes a signal generator 114, a data measuring unit 119, a phase detector 116, a delay calculator 118, and a delay unit 112.

The signal generator 114 generates a test tone to measure response characteristics of the subwoofer 180 and the main speaker 160. The test tone may include a white noise signal, a pink noise signal, or a sine sweep signal.

A first switch SW1 switches an input to the first amplifier 120 between the test tone generated by the signal generator 114 and a main audio signal, and the second switch SW2 switches an input to the second amplifier 140 between the test tone generated by the signal generator 114 and a subwoofer audio signal. For example, in order to measure a phase difference between a subwoofer channel and a main speaker channel, the test tone generated by the signal generator 114 is selected by the first and second switches SW1 and SW2 by contacting contact points 2 and 3 in each switch. Once the phase difference is measured, a subwoofer channel signal and a main speaker channel signal are selected by the first and second switches SW1 and SW2 by contacting contact points 1 and 3 in each switch.

The microphone 190 receives a sound output from the main speaker 160 and a sound output from the subwoofer 180 and converts the respective sounds into electrical signals.

The data measuring unit 119 measures response characteristics of the electrical signals that correspond to the test tones of the subwoofer 180 and the main speaker 160 sensed by the microphone 190. That is, the data measuring unit 119 measures a response characteristic A of a signal output from the main speaker 160, a response characteristic B of a signal output from the subwoofer 180, and a response characteristic X of a signal simultaneously output from the subwoofer 180 and the main speaker 160 according to the test tone. The phase detector 116 detects a phase difference between the subwoofer 180 and the main speaker 160 at a crossover frequency according to difference values between the respective response characteristics A and B of the subwoofer 180 and the main speaker 160 and the simultaneous response characteristic X of the subwoofer 180 and the main speaker 160.

The delay calculator 118 calculates a delay value d of the subwoofer 180 using the phase difference detected by the phase detector 116.

The delay unit 112 delays an input signal of the subwoofer 180 by the delay value d calculated by the delay calculator 118.

The first and second amplifiers 120 and 140 amplify the main audio signal and the subwoofer audio signal and output the amplified main audio and subwoofer audio signals to the main speaker 160 and the subwoofer 180, respectively.

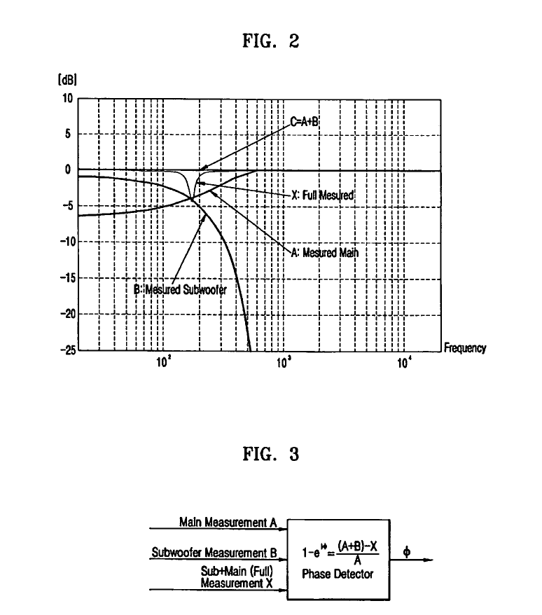

FIG. 2 is a diagram illustrating frequency responses of the main speaker channel and the subwoofer channel.

Referring to FIG. 2, A indicates a frequency response characteristic of a signal output from the main speaker 160 (see FIG. 1). B indicates a frequency response characteristic of a signal output from the subwoofer 180 (see FIG. 1). X indicates a frequency response characteristic of a test tone signal simultaneously output from the subwoofer 180 and the main speaker 160. C indicates a value obtained by arithmetically adding the frequency response characteristics A and B. Thus, C is not an actual measured value. As illustrated in FIG. 2, the frequency response characteristic B of the subwoofer 180 is crossed with the frequency response characteristic A of the main speaker 160 at a crossover frequency. Here, if an audio signal is simultaneously input to the main speaker 160 and the subwoofer 180, a notch is generated at a crossover point (i.e., that corresponds to the crossover frequency) when a phase of a main speaker channel signal differs from a phase of a subwoofer channel signal.

FIG. 3 is a diagram illustrating the phase detector 116 of the compensation apparatus of FIG. 1.

Referring to FIG. 3, the phase detector 116 detects a phase difference at a listening point (not shown) of the main speaker 160 and the subwoofer 180 using the measured frequency response characteristics A, B, and X of signals output from the main speaker 160 and the subwoofer 180.

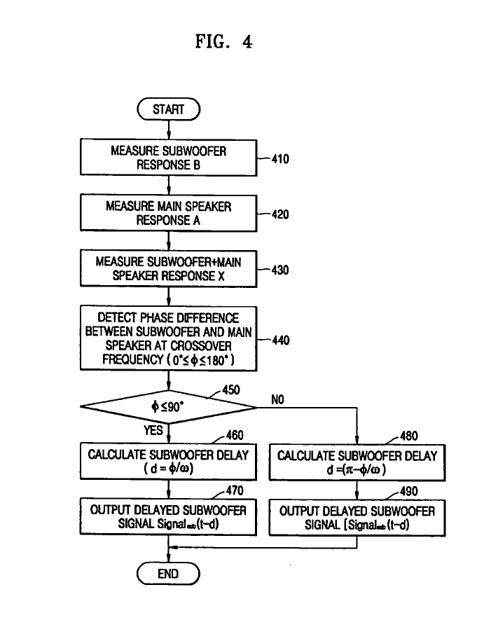

FIG. 4 is a flowchart illustrating a method of detecting and compensating a phase difference at a crossover point according to an embodiment of the present general inventive concept. The method of FIG. 4 is described below with reference to FIGS. 1 and 3.

Frequency response characteristics A and B of signals output from the main speaker 160 and the subwoofer 180 are measured using the microphone 190 in operations 410 and 420. A frequency response characteristic X of a test signal simultaneously output from the main speaker 160 and the subwoofer 180 is measured in operation 430. The frequency response characteristics A, B, and X are illustrated in FIG. 2. Here, an impulse noise signal, a white noise signal, a pink noise signal, or a sine sweep signal may be used as the test signal.

A phase difference between a subwoofer channel signal and a main speaker channel signal is detected according to difference values between the response characteristics A, B, and X of the main speaker 160 and the subwoofer 180 at a crossover frequency in operation 440. A maximum value of the phase difference may be limited to 180° in order for a delay time calculated by the delay calculator 118 not to exceed a half cycle due to the phase difference.

That is, when A indicates a magnitude of the response characteristic of the main speaker 160 measured at a crossover point (i.e., that corresponds to the crossover frequency) B indicates a magnitude of the response characteristic of the subwoofer 180 measured at the crossover point, and X indicates a magnitude of the response characteristic of the test tone signal simultaneously output from the main speaker 160 and the subwoofer 180 at the crossover point, the response characteristic X can be represented as Equation 1.
Ae^{jΦ}+B=X [Equation 1]

Here, Φ indicates a phase difference between signals output from the main speaker 160 and the subwoofer 180. If the phase difference is 0, Equation 2 is satisfied.
A+B=X [Equation 2]

Here, X is obtained by simply adding A and B. The phase difference is obtained by subtracting an arithmetic sum of the response characteristics A and B of signals output from the main speaker 160 and the subwoofer 180, respectively, from the response characteristic X of the test tone signal simultaneously output from the main speaker 160 and the subwoofer 180. Therefore, the phase difference Φ is obtained by subtracting (A+B) (Equation 3) from an actual measured value (Equation 4). In other words, the phase difference Φ can be obtained by subtracting Equation 3 in which there is no phase difference from Equation 4 in which there is a phase difference Φ.
A+B=A+B [Equation 3]
Ae^{jΦ}+B=X [Equation 4]

Equation 5 is obtained by subtracting Equation 3 from Equation 4.
1−e^{jΦ}=(A+B−X)/A

Therefore, finally, the phase difference Φ can be represented as Equation 6.
Φ=cos⁻¹{1−(A+B−X)/A} [Equation 6]

Here, e^{jΦ}=1−{(A+B−X)/A}, and Φ satisfies 0°≦Φ≦180°.

A delay value of the subwoofer 180 is calculated on the basis of the detected phase difference Φ.

That is, it is determined whether the detected phase difference Φ is less than or equal to 90° in operation 450.

If the detected phase difference Φ is less than or equal to 90°, the subwoofer delay value d is calculated by Equation 7 in operation 460.
d=Φ/\overline{ω} . . . [0°≦Φ≦90°], where \overline{ω} indicates the crossover frequency. [Equation 7]

If the detected phase difference Φ is greater than 90°, the subwoofer delay value d is calculated by Equation 8 in operation 480.
d=(180°−Φ)/ \overline{ω} . . . 90°≦Φ≦180°], where \overline{ω} indicates the crossover frequency. [Equation 8]

The phase difference Φ at the crossover point between the response characteristic A of the main speaker 160 and the response characteristic B of the subwoofer 180 is compensated for using the calculated delay value d and a corresponding sign. The corresponding sign refers to a state of a signal of the delay unit 112 to which the calculated delay value d is applied. If a signal input to the delay unit 112 is inverted the corresponding sign is negative, otherwise the corresponding sign is positive. The corresponding sign depends on the detected phase difference Φ. That is, if the detected phase difference Φ is less than or equal to 90°, a signal output to the subwoofer 180 can be represented by Equation 9.
S_{sub-out}=S_{sub}(t−d) . . . [0°≦Φ≦90°] [Equation 9]

If the detected phase difference Φ is greater than 90°, a signal output to the subwoofer 180 can be represented by Equation 10.
S_{sub-out}=−S_{sub}(t−d) . . . [90°≦Φ≦180°] [Equation 10]

Here, S_{sub} is a signal input to the delay unit 112 generated by a source decoder (not shown) or a pre-amplifier (not shown). According to Equation 10, when the delay value d is the largest (180°), the phase is inverted by multiplying −1 (i.e., the corresponding sign) by the signal input to the delay unit 112.

Finally, the signal output to the subwoofer 180 is phase-matched to a signal output to the main speaker 160 by adjusting the signal input to the delay unit 112 by the calculated delay value d and the corresponding sign.

The general inventive concept can also be embodied as computer-readable codes on a computer-readable recording medium. The computer-readable recording medium can include any data storage device that can store data which can be thereafter read by a computer system. Examples of the computer-readable recording medium include read-only memory (ROM), random-access memory (RAM), CD-ROMs, magnetic tapes, floppy disks, flash memory, optical data storage devices, and carrier waves (such as data transmission through the Internet). The computer-readable recording medium can also be distributed over network coupled computer systems so that the computer-readable code is stored and executed in a distributed fashion.

As described above, according to an embodiment of the present general inventive concept, a phase difference between a subwoofer channel signal and a main speaker channel signal is automatically checked, and a phase of the subwoofer channel signal is adjusted to compensate for the phase difference. Additionally, an audio signal with optimal sound quality can be reproduced by avoiding a complex analog phase shift for which a plurality of OP AMPs must be used and providing very accurate compensation degree using a relatively simple circuit.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of compensating for a phase difference between a main speaker and a subwoofer in an audio reproducing device having separate subwoofer and main speaker channels, the method comprising:
measuring a first response characteristic of a signal output from the subwoofer, a second response characteristic of a signal output from the main speaker, and a third response characteristic of a test signal simultaneously output from the subwoofer and the main speaker;
detecting a phase difference between the subwoofer and the main speaker according to a difference value between the first, second, and third response characteristics at a crossover frequency;
calculating a delay value of the subwoofer according to the detected phase difference; and
compensating for the detected phase difference at the crossover point between the subwoofer and the main speaker using the calculated delay value of the subwoofer.

2. The method of claim 1, wherein the detecting of the phase difference comprises:
detecting the phase difference by subtracting an arithmetic sum of the first and second response characteristics of the signals output from the subwoofer and the main speaker from the third response characteristic of the test signal simultaneously output from the main speaker and the subwoofer.

3. The method of claim 1, wherein the phase difference is obtained by
Φ=cos⁻¹{1−(A+B−X)/A}
where Φ indicates the phase difference, A indicates a magnitude of the second response characteristic of the main speaker measured at the crossover point, B indicates a magnitude of the first response characteristic of the subwoofer measured at the crossover point, and X indicates a magnitude of the third response characteristic of the test signal simultaneously output from the main speaker and the subwoofer at the crossover point.

4. The method of claim 1, wherein the calculating of the delay value comprises:
calculating the delay value according to Φ/\overline{ω} where Φ is the detected phase difference and \overline{ω} is the crossover frequency when the detected phase difference Φ is less than or equal to 90°; and
calculating the delay value according to (180°−Φ)/\overline{ω} where Φ is the detected phase difference and \overline{ω} is the crossover frequency when the detected phase difference Φ is greater than 90°.

5. The method of claim 1, wherein the compensating for the phase difference comprises:
adjusting a subwoofer input signal by the calculated delay value when the detected phase difference is less than or equal to 90°; and
inverting a phase of the subwoofer input signal and adjusting the phase-inverted subwoofer input signal by the calculated delay value when the detected phase difference is greater than 90°.

6. The method of claim 1, wherein the detecting of the phase difference comprises limiting the detected phase difference to 180 degrees such that the calculated delay value does not exceed a half cycle.

7. A method of compensating for a phase difference between a first speaker channel and a second speaker channel in an audio reproducing device, the method comprising:
measuring a first frequency response from a first speaker that corresponds to the first speaker channel, a second frequency response from a second speaker that corresponds to the second speaker channel, and a combined frequency response from the first and second speakers;
determining the phase difference according to the first and second frequency responses and the measured combined frequency response; and
adjusting a phase of an input signal of one of the first and second speaker channels according to the determined phase difference.

8. The method of claim 7, wherein the determining of the phase difference comprises determining the phase difference according to a difference between a sum of the first and second frequency responses and the measured combined frequency response.

9. The method of claim 7, wherein the measuring of the combined frequency response comprises:
simultaneously providing a first test signal corresponding to the first speaker to a first signal processing unit and a second test signal corresponding to the second speaker to a second signal processing unit;
individually processing the first and second test signals in the first and second signal processing units to induce the phase difference between the first and second test signals;
individually outputting the first and second test signals having the phase difference induced therebetween from the first and second speakers; and
measuring the combined frequency response of the output first and second test signals.

10. The method of claim 9, wherein the individually processing of the first and second test signals comprises amplifying the first and second test signals, respectively.

11. The method of claim 7, wherein the determining of the phase difference comprises:
approximating an in-phase combined frequency response as an arithmetic sum of the first and second frequency responses; and
subtracting the in-phase combined frequency response from the measured combined frequency response to determine the phase difference.

12. The method of claim 7, wherein the adjusting of the phase of the input signal of one of the first and second speaker channels according to the determined phase difference comprises:
calculating a delay by dividing the determined phase difference by the crossover frequency and adjusting the input signal of the one of the first and second speaker channels by the calculated delay when the determined phase difference is less than or equal to 90 degrees; and
calculating the delay by dividing 180 degrees minus the phase difference by the crossover frequency and adjusting a phase inversion of the input signal of the one of the first and second speaker channels when the determined phase difference is between 90 degrees and 180 degrees.

13. An apparatus to compensate for a phase difference between a main speaker and a subwoofer in an audio reproducing device having separate subwoofer and main speaker channels, comprising:
a data measuring unit to measure a first response characteristic of a signal output from the subwoofer, a second response characteristic of a signal output from the main speaker, and a third response characteristic of a test signal simultaneously output from the subwoofer and the main speaker;
a phase detector to detect a phase difference between the subwoofer and the main speaker at a crossover frequency according to a difference value between the first, second, and third response characteristics measured by-the data measuring unit;
a delay unit to delay an input signal of a subwoofer channel by a delay value of the subwoofer determined according to the phase difference detected by the phase detector.

14. The apparatus of claim 13, further comprising:
a signal generator to generate a test tone to measure the third response characteristics of the subwoofer and the main speaker.

15. The apparatus of claim 13, further comprising:
a signal processing unit to generate the phase difference while processing a main audio signal to be output by the main speaker and a subwoofer audio signal to be output by the subwoofer.

16. The apparatus of claim 15, wherein the signal processing unit comprises:
a first amplifier to amplify the main audio signal to be output by the main speaker; and
a second amplifier to amplify the subwoofer audio signal to be output by the subwoofer.

17. The apparatus of claim 15, further comprising:
a test signal generator to generate the test signal;
a switching unit in communication with the test signal generator and the signal processing unit to switch the test signal and the main and subwoofer audio signals; and
an input unit that receives the main and subwoofer audio signals,
wherein the switching unit outputs the test signal to the signal processing unit in a phase determination state and outputs the main and subwoofer audio signals to the signal processing unit in an audio signal output state.

18. The apparatus of claim 13, further comprising:
a microphone to detect audio output from the main speaker and the subwoofer, to convert the audio output to one or more electrical signals, and to provide the one or more electrical signals to the data measuring unit.

19. The apparatus of claim 13, wherein the test signal comprises at least one of a white noise signal, a pink noise signal, and a sine sweep signal.

20. An apparatus to compensate for a phase difference between a first speaker channel and a second speaker channel in an audio reproducing device, comprising:
a data measuring unit to measure a first frequency response from a first speaker that corresponds to the first speaker channel, a second frequency response from a second speaker that corresponds to the second speaker channel, and a combined frequency response from the first and second speakers;
a phase detector to determine the phase difference according to the first and second frequency responses and the measured combined frequency response; and
a delay unit to adjust a phase of an input signal of one of the first and second speaker channels according to the determined phase difference.

21. The apparatus of claim 20, further comprising:
a first signal processing unit and a second signal processing unit to individually process a first signal corresponding to the first speaker and a second signal corresponding to the second speaker, respectively, and inducing the phase difference between the first and second signals; and
a signal generator to simultaneously provide a first test signal to be output by the first speaker to the first signal processing unit and a second test signal to be output by the second speaker to the second signal processing unit,
wherein the first and second speakers output the first and second test signals having the phase difference induced therebetween, and the data measuring unit measures the combined frequency response of the output first and second test signals.

22. The apparatus of claim 20, wherein the phase detector approximates an in-phase combined frequency response as an arithmetic sum of the first and second frequency responses, and subtracts the in-phase combined frequency response from the measured combined frequency response to determine the phase difference.

23. The apparatus of claim 20, further comprising:
a delay calculator to calculate a delay by dividing the determined phase difference by the crossover frequency and to adjust the input signal of the one of the first and second speaker channels by the calculated delay when the determined phase difference is less than or equal to 90 degrees, and to calculate the delay by dividing 180 degrees minus the phase difference by the crossover frequency and adjusting a phase inversion of the input signal of the one of the first and second speaker channels when the determined phase difference is between 90 degrees and 180 degrees.

24. An audio reproducing device having separate subwoofer and main speaker channels, the device comprising:
a micro-processor to detect a phase difference at a crossover point using difference values between respective response characteristics of signals output from a subwoofer and a main speaker and a response characteristic of a test signal simultaneously output from the subwoofer and the main speaker and to delay a subwoofer audio signal by a delay value of the subwoofer determined according to the detected phase difference; and
amplifiers to respectively amplify a main speaker audio signal and the delayed subwoofer audio signal output from the micro-processor.

25. An audio reproducing apparatus, comprising:
a microprocessor to measure a first frequency response from a first speaker that corresponds to a first speaker channel, a second frequency response from a second speaker that corresponds to a second speaker channel, and a combined frequency response from the first and second speakers, to determine the phase difference according to a difference between a sum of the first and second frequency responses and the measured combined frequency response, and to adjust a phase of an input signal of one of the first and second speaker channels according to the determined phase difference; and
a signal processing unit to induce the phase difference between the first and second speaker channels before being output to the first and second speakers, respectively.

26. The apparatus of claim 25, wherein the first and second speakers comprise a main speaker and a subwoofer.

27. A computer readable medium having executable code to compensate for a phase difference between a main speaker and a subwoofer in an audio reproducing device having separate subwoofer and main speaker channels, the medium comprising:
a first code to measure a first response characteristic of a signal output from the subwoofer, a second response characteristic of a signal output from the main speaker, and a third response characteristic of a test signal simultaneously output from the subwoofer and the main speaker;
a second code to detect a phase difference between the subwoofer and the main speaker according to a difference value between the first, second, and third response characteristics at a crossover frequency;
a third code to calculate a delay value of the subwoofer according to the detected phase difference; and
a fourth code to compensate for the detected phase difference at the crossover point between the subwoofer and the main speaker using the calculated delay value of the subwoofer.
